(19) United States
(12) Patent Application Publication
(10) Pub. No.: US 2010/0096785 A1
(43) Pub. Date: Apr. 22, 2010

(54) DEVICE FOR INTRODUCING METAL BARS INTO A METAL BATH

(76) Inventors: Peter de Kock, Oberhausen (DE); Matthias Kretschmer, Koln (DE); Holger Behrens, Erkrath (DE)

Correspondence Address: FRIEDRICH KUEFFNER, 317 MADISON AVENUE, SUITE 910, NEW YORK, NY, 10017, US

(21) Appl. No.: 12/450,640

(22) PCT Filed: Feb. 20, 2008
(86) PCT No.: PCT/EP2008/001310

§ 371 Date: Nov. 16, 2009

(30) Foreign Application Priority Data
Apr. 3, 2007 (DE) 10 2007 015 964.3

(51) Int. Cl. F27D 13/00; F27D 3/00

(52) U.S. Cl. 266/200

(57) ABSTRACT

The invention relates to a device (1) for inserting metal ingots (2) into a metal bath (3), in particular zinc ingots into a zinc bath, wherein the device (1) comprises feed means (4) with which an ingot (2) can be fed to the metal bath (3), and wherein the device (1) comprises heating means (5) with which the ingot (2) can be heated to a desired temperature before and/or after its feeding into the metal bath (3). In order to improve the process control, it is provided according to the invention that the heating means (5) comprise at least one independently operated heating element which can be operated independently of other system parts with which the device (1) cooperates.

The invention relates to a device for inserting metal ingots into a metal bath, in particular zinc ingots into a zinc bath, wherein the device comprises feed means with which an ingot can be fed to the metal bath, and wherein the device comprises heating means with which the ingot can be heated to a desired temperature before and/or after its feeding into the metal bath.

In hot dip galvanising lines, the strip to be galvanised is passed through a metal bath containing a liquid zinc alloy. In this case, the zinc used for the coating is thereby removed continuously from the zinc bath. Therefore zinc must be supplied subsequently to the bath to maintain a constant degree of filling of the zinc bath.

Charging devices are known for this purpose whereby metal ingots can be conveyed into the container containing the metal melt. In this case, the disadvantage arise that the temperature of the metal melt is subject to fluctuations as new ingot material is added. The cold supplied ingots cool the melt in the receiving container by withdrawing heat, in particular in the area of the feed point so that the coating process is disturbed, Another disadvantage is that this promotes the formation of zinc slag.

It is therefore known to initially melt the melt to be fed to the metal bath in a pre-melting container which is separate from the actual coating bath and then add the melt, which is temperature-controlled in this respect, to the coating bath free from slag. The slag is removed in the pre-melting container. A disadvantage here however is that it is relatively expensive to use a pre-melting container; the system requires additional space and is expensive.

In order to avoid disadvantages it has become known from EP 1 091 011 B1 to preheat the metal ingots to be supplied before feeding them into the melt container. This takes place such that the heat of a furnace required in any case for the hot dip coating process is fed to the ingots to be supplied to heat them to a desired temperature. In this case, hot air is fed from the furnace via a blower to a heat exchanger to heat the air which then heats the ingots.

A similar solution is known from JP 1128 1264. Here also heat is guided from a smelting furnace in the form of hot air to the ingots to be supplied, which are then supplied to the metal bath when they reach a certain temperature.

A disadvantage with the methods described previously is that they are relatively difficult to control. By using the (waste) heat from a furnace close to the insertion device for the ingots, it is certainly possible to use the energy from this furnace. However, the heat exchange process is relatively slow so that the ingots to be supplied cannot easily be heated precisely and rapidly.

It is thus the object of the invention to remedy this situation and provide a device for inserting metal ingots into a metal bath in which this negative effect cannot occur. The device should be characterised in that process control is simpler and the necessary parameters can be regulated accurately and rapidly.

This object is achieved according to the invention in that the heating means of the device comprises at least one independently operated heating element which can be operated independently of other system parts with which the device cooperates.

Since the proposed heating element is not dependent on an energy supply from another part of the system, the temperature of the ingot to be supplied can be controlled much more rapidly and precisely so that process control is easier.

The heating element can comprise a gas burner or an electrically operated element; in the latter case, an induction heating element is particularly suitable.

The feed means can comprise a retaining device for at least one ingot with which the ingot can be held so that it at least partially dips in the metal bath. The feed device is preferably fitted with movement means which can move it from a first position in which the ingot is located outside the metal bath and a second position in which the ingot is located at least partially inside the metal bath. The movement means of the retaining device can be designed so that it can execute a combined lifting and tipping movement of the retaining device. The ingot to be melted can thus be inserted precisely into the metal bath so that a desired degree of melting of the metallic material takes places.

In such a solution it is then advantageously provided that the heating means are movably disposed on the feed means, in particular in the area of the heating device.

Alternatively however, it is also possible that in the area of the feed means the heating means are located fixedly in the conveying direction before the metal bath. The heating means can thereby be disposed in the area of a part of the feed means on which the ingot is conveyed in the horizontal direction.

In order to allow automated operation as far as possible, the device preferably comprises conveying means for preferably automatic conveyance of ingots from a mounting or storage station to the retaining device. The conveying means can comprise a walking-beam conveyor and/or a slide mechanism. The conveying means can charge two parallel retaining means for ingots.

With the proposed device it is possible to pre-heat, the temperature of the ingot to be supplied to the metal bath rapidly and exactly to a desired temperature so that optimum process control can be achieved. The pre-heating takes place in a precise and economic manner.

With the proposed measures, it is furthermore possible to incorporate the ingot heating in the regulation of the bath level. An increase in the pre-heating temperature promotes melting of the ingot. This increases the bath level. Conversely, a reduction in the pre-heating leads to a reduction in the bath level.

Exemplary embodiments of the invention are shown in the drawings. In the figures:

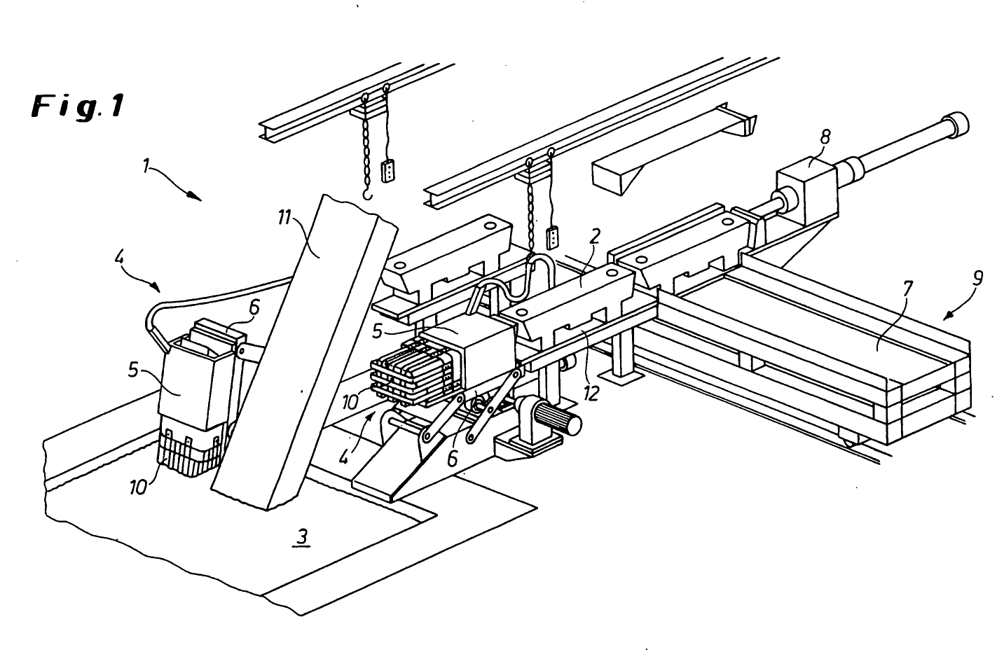

FIG. 1 is a perspective view of a zinc ingot charging device according to a first embodiment; and

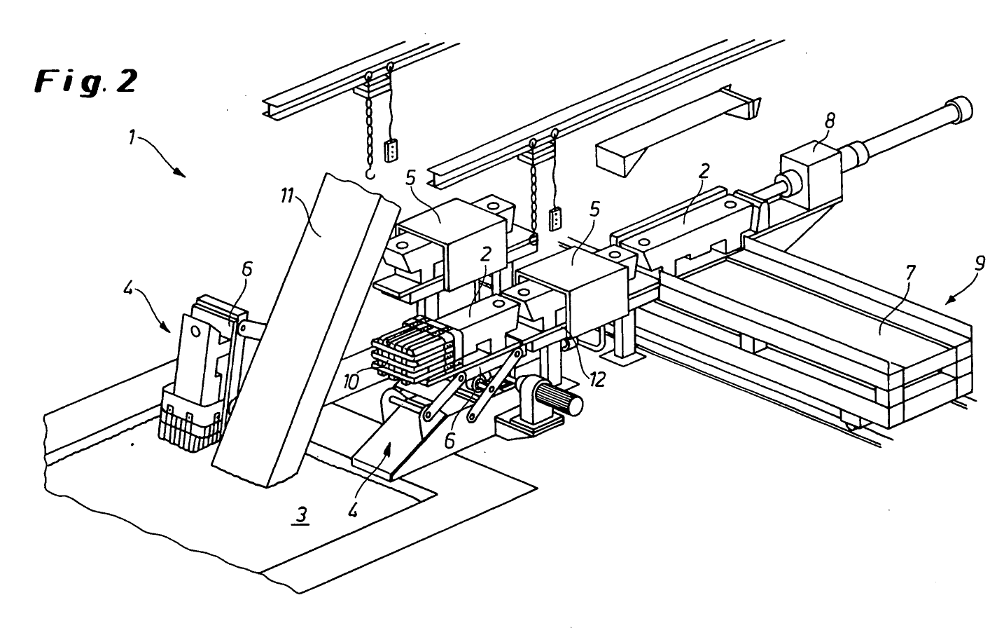

FIG. 2 is a perspective view of an alternative embodiment of the zinc ingot charging device.

FIG. 1 shows a device 1 for inserting zinc ingots 2 into a metal bath 3. A furnace tuyere snout 11 projects from the metal bath 3 in the usual manner and the metal strip (not shown) to be coated is guided therein. The ingots 2 are fed into the metal bath 3 with the feed means 4 shown. A component of the feed means 4 is a retaining device 6 which holds the ingot 6 to be inserted into the metal bath 3 such that it dips into the bath 3 to a desired degree and can thus melt.

An important component of the device 1 is a heating means 5 which comprises an independently operated heating element (not shown in detail) which can be operated independently of the other system parts with which the device 1 cooperates. In particular, the heating element has its own power supply which is not coupled to other system parts. In particular, the heat of another furnace is not used to heat the ingots 2.

A gas burner or an electrical heating device can be used as the heating element. In particular, it has proved particularly successful to use induction heating whereby the ingot 2 can be heated rapidly.

A particular feature is that the heating means 5 are arranged to be movable. As can be seen from a combined view of the two charging devices 1 in FIG. 1, the heating means 5 co-executes the (lifting and tilting) movement of the retaining device 6. Thus, the ingot 2 can be held in a precisely temperature-controlled manner before dipping into the metal bath 3. The heating means 5 are therefore fixed co-movably on the charging device. The ingot 2 can be heated constantly and can itself be temperature-controlled during the melting process.

Another possibility is shown in FIG. 2. There the heating means 5 are arranged stationarily and specifically in the region above which the ingot 2 is guided horizontally on the feed means 4. In this case, the ingot 2 can be heated in a waiting position whilst the preceding ingot is melted in the metal bath. The thus preheated ingot 2 thereby reduces the temperature difference which it would have caused without preheating when dipped into the metal bath.

The figures show an arrangement in which two charging devices 1 are arranged laterally adjacent to the furnace tuyere snout 11. The left or rear charging device thereby dips the metal ingot 2 directly into the metal bath 3 so that it can melt. The right or front charging device 1 holds the ingot 2 in a position in which it does not yet dip in. As can be seen, the retaining device 6 can be moved between two positions, i.e. between a first position (to the right or the front) in which the metal ingot 2 is not yet dipping into the metal bath 3 and a second position (to the left or the back) in which the ingot 2 dips in and melts. In this case, the ingot 2 is held by a basket element 10.

The general handling of the ingot 2 can be seen from the further apparatus configuration according to the figures: the zinc ingot 2 is inserted by means of a fork lift truck on a mounting or storage station 9 located at the end of a walking-beam conveyor 7. The ingots 2 are preferably placed from the operating side onto the walking-beam conveyor 7 which is configured as a step conveyor. The zinc ingots 2 are conveyed to the centre of the system by the conveying movement of the walking-beam conveyor 7.

Once the zinc ingots 2 have arrived at the end of the walking-beam conveyor 7, they are transported further by an allocated slider mechanism 8; the zinc ingot 2 is now pushed in the direction of the retaining device 6 at an angle of 90° to the feed conveyor 7. A transfer table 12 having a stainless steel plate over which the ingots 2 are pushed is used as the transport surface. Between the conveyor 7 and the retaining device 6 is an intermediate position. This serves to bridge the distance between the conveyor 7 and the retaining device 6 and as a storage device in the event that there is a supply bottleneck in the delivery of the zinc ingots.

The lift of the sliding mechanism 8 transports the ingot 2 from the conveyor 7 to the intermediate position and at the same time transports the ingot 2 from the intermediate position into or onto the retaining device 6. After loading with an ingot 2, the retaining device 6 lifts the zinc ingot 2 from the transfer table 12 by means of a movement means not shown in detail and at the same time tips the ingot 2 in the direction of the metal bath 3. In this case, the zinc ingot 2 rests on the basket element 10. In the last section of the travel, the basket element 10 with the zinc ingot 2 is dipped into the liquid zinc in the metal bath 3.

### REFERENCE LIST

1 Device for inserting metal ingots

2 Metal ingot (zinc ingot)

3 Metal bath

4 Feed means

5 Heating means

6 Retaining device

7 Conveying means (walking-beam conveyor)

8 Conveying means (slide mechanism)

9 Mounting or storage station

10 Basket element

11 Furnace tuyere snout

12 Transfer table

1. A device (1) for inserting metal ingots (2) into a metal bath (3), wherein the device (1) comprises feed means (4) with which an ingot (2) can be fed to the metal bath (3), wherein the device (1) comprises heating means (5) with which the ingot (2) can be heated to a desired temperature before and/or during its feeding into the metal bath (3), and wherein the heating means (5) comprises at least one independently operated heating element which can be operated independently of other installation parts with which the device (1) interacts wherein the heating means (5) are movably disposed on the feed means (4).

2. The device according to claim 1, wherein the heating element is a gas burner.

3. The device according to claim 1, wherein the heating element is an electrically operated element.

4. The device according to claim 3, wherein the heating element is an induction heating element.

5. The device according to claim 1, wherein the feed means (4) comprise a retaining device (6) for at least one ingot (2) with which the ingot (2) can be held so that it at least partially dips in the metal bath (3).

6. The device according to claim 5, wherein the retaining device (6) is fitted with movement means which can move it from a first position in which the ingot (2) is located outside the metal bath (3) and a second position in which the ingot (2) is located at least partially inside the metal bath (3).

7. The device according to claim 6, wherein the retaining device (6) is designed so that it can execute a combined lifting and tipping movement of the retaining device (6).

8. The device according to claim 5, wherein this comprises conveying means (7, 8) for conveying ingots (2) from a mounting or storage station (9) to the retaining device (6).

9. The device according to claim 8, wherein the conveying means (7, 8) comprise a walking-beam conveyor (7) and/or a slide mechanism (8).

10. The device according to claim 5, wherein the heating means (5) are movably disposed on the feed means (4) in the area of the retaining device (6).
